(19) United States
(12) Patent Application Publication
(10) Pub. No.: US 2024/0411517 A1
(43) Pub. Date: Dec. 12, 2024

(54) DATA PROCESSING DEVICE, DATA PROCESSING METHOD, AND CHIP

(71) Applicant: Rockchip Electronics Co., Ltd., Fuzhou (CN)

(72) Inventor: Fei ZENG, Fuzhou (CN)

(73) Assignee: Rockchip Electronics Co., Ltd., Fuzhou (CN)

(21) Appl. No.: 18/735,119

(22) Filed: Jun. 5, 2024

(30) Foreign Application Priority Data
Jun. 12, 2023 (CN) 2023106920957

(51) Int. Cl. G06F 7/523; G06F 7/50

(52) U.S. Cl. CPC G06F 7/523; G06F 7/50

(57) ABSTRACT

A data processing device, a data processing method, and a chip are provided. The data processing device includes a multiplying accumulator. The multiplying accumulator is configured to obtain an input tensor and a sparse weight tensor. The sparse weight tensor is obtained by performing a sparse processing on at least one of a first dimension and a second dimension of an original weight tensor. The multiplying accumulator is further configured to perform a multiply-accumulate (MAC) operation on the sparse weight tensor and the input tensor. The present disclosure enhances the computational power of the data processing device without increasing the number of multiplying accumulators.

### FIELD OF THE INVENTION

The present disclosure relates to the technical field of data processing, and in particular, to a data processing device, a data processing method, and a chip.

### BACKGROUND OF THE INVENTION

In various scientific computations and engineering applications, the multiply-accumulate (MAC) operation is fundamental. It combines a result of a multiplication operation with another operand and then adds them together to obtain the final result. In the traditional technology, MAC operations are primarily implemented using multiplying accumulators within data processing devices. One widely used form of MAC operations is convolution, which involves input features, weights, biases, and output features. In traditional convolution, the input features are multiplied and added to a set of weights, followed by the addition of a bias term to produce the output features.

### SUMMARY OF THE INVENTION

The present disclosure provides a data processing device, a data processing method, and a chip to enhance the computational power of data processing devices when handling MAC operations.

A first aspect of the present disclosure provides a data processing device. The data processing device includes a multiplying accumulator. The multiplying accumulator is configured to obtain an input tensor and a sparse weight tensor. The sparse weight tensor is obtained by performing a sparse processing on at least one of a first dimension and a second dimension of an original weight tensor. The multiplying accumulator is further configured to perform a multiply-accumulate (MAC) operation on the sparse weight tensor and the input tensor.

In one embodiment of the first aspect, the input tensor includes data from an original input tensor corresponding to reserved positions of the sparse processing.

In one embodiment of the first aspect, the data processing device further includes an input circuit. The input circuit is configured to obtain a position index that contains reserved positions of the sparse processing; and read, based on the position index, data from an original input tensor corresponding to the reserved positions as the input tensor.

In one embodiment of the first aspect, the data processing device further includes an input circuit. The input circuit is configured to read an original input tensor as the input tensor. The multiplying accumulator is configured to obtain a position index that contains reserved positions of the sparse processing; and perform, based on the position index, a MAC operation on data from the input tensor corresponding to the reserved positions and the sparse weight tensor.

In one embodiment of the first aspect, the data processing device further includes a controller. The controller is configured to perform the sparse processing on the original weight tensor to obtain the sparse weight tensor.

In one embodiment of the first aspect, the input circuit is configured to read the sparse weight tensor, and the sparse weight tensor is obtained by performing the sparse processing on the original weight tensor.

In one embodiment of the first aspect, the sparse weight tensor is obtained by performing a first sparse processing on the original weight tensor in the first dimension, and wherein the first sparse processing adopts a first sparse granularity.

In one embodiment of the first aspect, the first sparse granularity is m:n, and every set of n data points of the original weight tensor in the first dimension is reduced into m data points through sparsification, wherein m and n are both positive integers and n>m.

In one embodiment of the first aspect, the first sparse processing uses m×ceil(log₂ n) bits of position indexes to represent sparse positions, and each data point obtained through sparsification uses ceil(log₂ n) bits of position indexes to represent its position, wherein ceil is a round-up function.

In one embodiment of the first aspect, the first sparse processing uses ceil(log₂(Cₙ^{m})) bits to represent Cₙ^{m} sparsification manners, and selects one of the Cₙ^{m} sparsification manners for execution, wherein ceil is a round-up function.

In one embodiment of the first aspect, the first sparse processing uses ceil(log₂ N) bits to represent N sparsification manners, and selects one of the N sparsification manners for execution, wherein N is an integer smaller than Cₙ^{m}, ceil is a round-up function, and the N sparsification manners are selected from the Cₙ^{m} sparsification manners.

In one embodiment of the first aspect, the sparse weight tensor is obtained by performing a second sparse processing on the original weight tensor in the second dimension, and wherein the second sparse processing adopts a second sparse granularity.

In one embodiment of the first aspect, the second sparse granularity is s:r, and every set of r data points of the original weight tensor in the second dimension is reduced into s data points through sparsification, wherein r and s are both positive integers and r>s.

In one embodiment of the first aspect, an intermediate tensor is obtained by performing one of a first sparse processing and a second sparse processing on the original weight tensor in one of the first dimension and the second dimension, and the sparse weight tensor is obtained by performing the other of the first sparse processing and the second sparse processing on the intermediate tensor in the other of the first dimension and the second dimension, wherein the first sparse processing adopts a first sparse granularity, and the second sparse processing adopts a second sparse granularity.

In one embodiment of the first aspect, the first dimension is a channel direction of the original weight tensor, and the second dimension is a kernel direction of the original weight tensor.

In one embodiment of the first aspect, the sparse weight tensor is obtained by further performing a third sparse processing on the original weight tensor in a third dimension, and the third sparse processing adopts a third sparse granularity.

A second aspect of the present disclosure provides a data processing method. The data processing method includes obtaining an input tensor and a sparse weight tensor, wherein the sparse weight tensor is obtained by performing a sparse processing on at least one of a first dimension and a second dimension of an original weight tensor; and performing a MAC operation on the sparse weight tensor and the input tensor.

A third aspect of the present disclosure provides a chip. The chip includes a data processing device. The data processing device comprises: a multiplying accumulator, configured to: obtain an input tensor and a sparse weight tensor, wherein the sparse weight tensor is obtained by performing a sparse processing on at least one of a first dimension and a second dimension of an original weight tensor; and perform a MAC operation on the sparse weight tensor and the input tensor.

In the present disclosure, the multiplying accumulator performs the MAC operation using the sparse weight tensor and the input tensor, obtaining a MAC result of the original input tensor and the original weight tensor. The sparse weight tensor is obtained by performing the sparse processing on the original weight tensor, resulting in fewer data points within the sparse weight tensor compared to the original weight tensor. Compared to directly using the original input tensor and original weight tensor for MAC operations, the present disclosure reduces the computational workload. As a result, the data processing device's overall computational power is enhanced without increasing the number of multiplying accumulators.

Furthermore, the data processing device of the present disclosure achieves a smaller design footprint and lower power consumption compared to related technologies while maintaining consistent computational performance.

Additionally, in the present disclosure, the multiplying accumulator only needs to read the sparse weight tensor and index, reducing the weight read bandwidth.

Lastly, the flexibility to configure different sparse parameters makes the data processing device of the present disclosure suitable for various application scenarios.

### BRIEF DESCRIPTION OF DRAWINGS

FIG. 1 shows a schematic structural diagram of a data processing device according to an embodiment of the present disclosure.

FIG. 2 shows a flowchart of a data processing method according to an embodiment of the present disclosure.

FIG. 3A shows a flowchart of obtaining an input tensor according to an embodiment of the present disclosure.

FIG. 3B shows a schematic diagram of an original input tensor according to an embodiment of the present disclosure.

FIG. 3C shows a schematic diagram of a position index matrix according to an embodiment of the present disclosure.

FIG. 3D shows a schematic diagram of an original input tensor according to another embodiment of the present disclosure.

FIG. 4 shows a flowchart of performing a MAC operation according to an embodiment of the present disclosure.

FIG. 5 shows a schematic diagram of a sparse processing according to an embodiment of the present disclosure.

FIG. 6 shows a schematic diagram of a sparse processing according to another embodiment of the present disclosure.

### DETAILED DESCRIPTION OF THE INVENTION

The embodiments of the present disclosure will be described below. Those skilled can easily understand disclosure advantages and effects of the present disclosure according to contents disclosed by the specification. The present disclosure can also be implemented or applied through other different specific embodiments. Various details in this specification can also be modified or changed based on different viewpoints and applications without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

In practical applications, different tensors are multiplied by various weights and then summed to perform a class of widely used operations known as multiply-accumulate, or MAC, operations. These operations include matrix multiplication, convolution, and deconvolution. Taking convolution as an example, a traditional convolution operation involves input features, weights, biases, and output features. During this operation, the input features are multiplied and added to a set of weights, followed by the addition of a bias term to produce the output features. The specific formula can be expressed as follows.

$$out ( {N}_{i} , {C}_{{out}_{j}} ) = bias ( {C}_{{out}_{j}} ) + {\sum }_{k = 0}^{{C}_{in} - 1} ( {C}_{{out}_{j}} , k ) \times input ( {N}_{i} , k ) \qquad Equation 1$$

wherein out (Nᵢ,Cₒᵤₜ_{ⱼ}) represents a complete output feature map of convolution, N represents a feature map batch, Cₒᵤₜ_{ⱼ} represents an output feature map channel, bias (Cₒᵤₜ_{ⱼ}) represents a bias corresponding to Cₒᵤₜ_{ⱼ}, Cᵢₙ represents an input feature map channel, and input(Nᵢ,k) represents a complete input feature map of convolution.

In the field of artificial intelligence (AI), convolutional operations are typically implemented using the multiplying accumulators within neural-network processing units (NPUs). However, as AI technology becomes more widespread and algorithms continue to evolve, the computational demands on NPUs are increasing. The area and power consumption required by NPUs are also growing.

In view of the above-mentioned shortcomings, the present disclosure provides a data processing solution for NPUs. Within the data processing device, the multiplying accumulator performs a MAC operation using a sparse weight tensor and an input tensor, obtaining a MAC result of an original input tensor and an original weight tensor. The input tensor can include various types of data, including image tensors, video tensors, audio signal tensors, and/or text tensors used in natural language processing. The corresponding output tensor is a feature map or feature representation obtained after processing the input tensor. The sparse weight tensor is obtained by performing sparse processing on the original weight tensor, resulting in fewer data points within the sparse weight tensor compared to the original weight tensor. Consequently, compared to directly using the original input tensor and original weight tensor for MAC operations, the present disclosure reduces the computational workload. As a result, the data processing device's overall computational power is enhanced without increasing the number of multiplying accumulators.

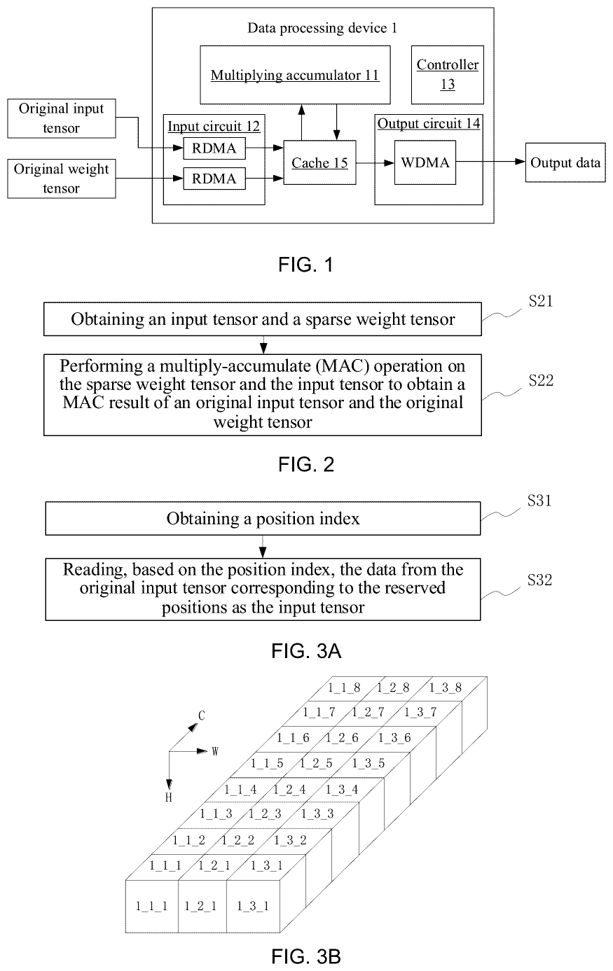

FIG. 1 shows a schematic structural diagram of a data processing device 1 according to an embodiment of the present disclosure. The data processing device 1 may be various processing devices capable of MAC operations, for example, in some embodiments, the data processing device 1 may be an NPU. As shown in FIG. 1, the data processing device 1 of the present disclosure includes a multiplying accumulator 11. In some embodiments, there are more than one such multiplying accumulators 11, and the number of multiplying accumulators 11 can be adjusted as needed. A computational power of the data processing device is mainly determined by specifications of the multiplying accumulators. For example, if the number of the multiplying accumulators in the data processing device is 1024, each of the multiplying accumulators operates twice in one clock cycle, and an operation frequency of the multiplying accumulator is 1 GHz, then the computational power of the data processing device is TOPs=1024×2×1 GHz=2TOPs, indicating that the data processing device can perform 2T operations per second.

In an embodiment of the present disclosure, in order to increase a computational power of the multiplying accumulator 11, the multiplying accumulator 11 is configured to perform a data processing method shown in FIG. 2. As shown in FIG. 2, the data processing method includes steps S21 and S22 described below.

Step S21 includes obtaining an input tensor and a sparse weight tensor. The sparse weight tensor is obtained by performing a sparse processing on at least one of a first dimension and a second dimension of an original weight tensor, resulting in fewer data points within the sparse weight tensor compared to the original weight tensor. The first dimension and the second dimension are different.

Step S22 includes performing a MAC operation on the sparse weight tensor and the input tensor to obtain a MAC result of an original input tensor and the original weight tensor.

In some possible embodiments, the input tensor includes data from the original input tensor corresponding to reserved positions of the sparse processing. Specifically, the data from the original input tensor corresponding to the reserved positions of the sparse processing is reserved, and data other than this is deleted, thereby obtaining the input tensor.

In some possible embodiments, the data processing device 1 may further include an output circuit 14 and a cache 15. The cache 15 is configured to store the input tensor, the sparse weight tensor, and the MAC result. The multiplying accumulator 11 is configured to read the input tensor and the sparse weight tensor from the cache 15 to perform a MAC operation, and store the MAC result into the cache 15. The output circuit 14 is configured to output the MAC result in the cache 15.

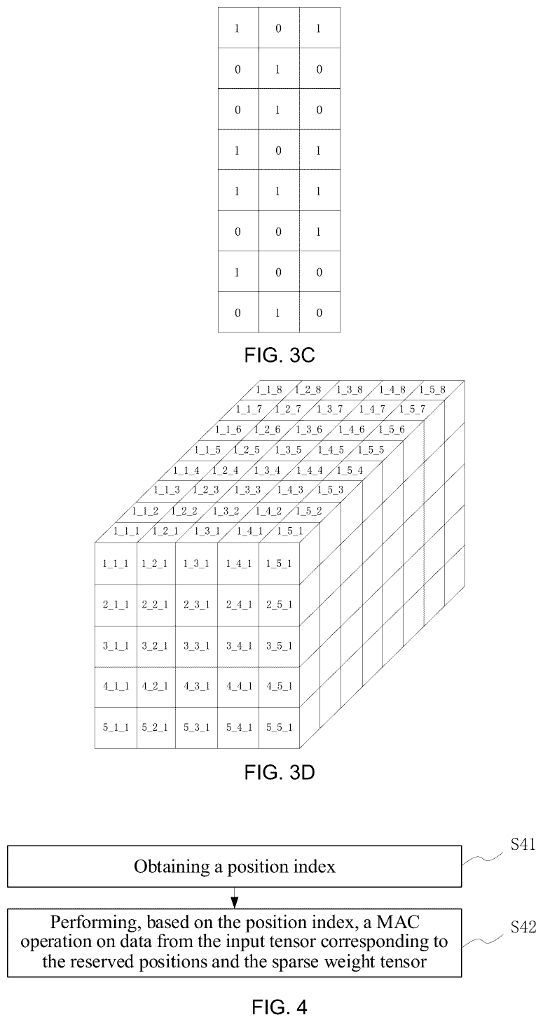

According to an embodiment of the present disclosure, the data processing device 1 may further include an input circuit 12. For example, the input circuit 12 may perform data reading by read direct memory access (RDMA) technologies. In an embodiment of the present disclosure, the input circuit 12 is configured to perform steps S31 and S32 shown in FIG. 3A.

Step S31 includes obtaining a position index. The position index includes reserved positions of the sparse processing. In some possible embodiments, the position index may be represented by a position index matrix. In the position index matrix, element 1 represents a reserved position, and element 0 represents a sparse position.

Step S32 includes reading, based on the position index, the data from the original input tensor corresponding to the reserved positions as the input tensor.

Next, the above process will be described in detail through a specific embodiment. FIG. 3B shows a schematic diagram of the original input tensor according to the specific embodiment. As shown in FIG. 3B, the original input tensor has a size of 1×8×3×1 (represented in the format of NCHW, where N represents a batch direction, C represents a channel direction, H represents a height direction, and W represents a width direction). FIG. 3C shows a schematic diagram of the position index matrix according to the specific embodiment, which illustrates the reserved positions and sparse positions in the channel direction. In the position index matrix, data points of first row correspond to data points 1_1_1, 1_2_1 and 1_3_1 in the original input tensor, data points of second row correspond to data points 1_1_2, 1_2_2, and 1_3_2 in the original input tensor, and so on. Based on the original input tensor shown in FIG. 3B and the position index matrix shown in FIG. 3C, the input circuit 12 may read, based on positions of element 1 in the position index matrix, the data from the original input tensor corresponding to the reserved positions as the input tensor. For example, during one reading process, the input circuit 12 may read data points 1_1_1 and 1_3_1 corresponding to element 1 of the data points of first row in the position index matrix and skip data point 1_2_1 corresponding to element 0. During another reading process, the input circuit 12 may read data point 1_2_2 corresponding to element 1 of the data point of second row in the position index matrix and skip data points 1_1_2 and 1_3_2 corresponding to element 0. In this way, the input circuit 12 may read 12 data points in the original input tensor as the input tensor. The multiplying accumulator 11 may perform the MAC operation using data corresponding to the twelve data points and the sparse weight tensor to obtain the MAC result of the original input tensor and the original weight tensor.

In some possible embodiments, the data processing device 1 may be configured to implement a convolution operation. FIG. 3D shows a schematic diagram of an original input tensor in the convolution operation. As shown in FIG. 3D, the original input tensor has a size of 1×8×5×5 (in the format of NCHW). Element 0 represents a pad value, and element 1 represents a stride value. The input circuit 12 reads, based on the position index matrix shown in FIG. 3C, data corresponding to twelve data points in a first matrix of 1×8×3×1 as one input tensor, data corresponding to twelve data points in a second matrix of 1×8×3×1 as another input tensor, data corresponding to twelve data points in a third matrix of 1×8×3×1 as yet another input tensor, and so on. The multiplying accumulator 11 performs the MAC operation using the sparse weight tensor and the input tensors read by the input circuit to obtain a MAC result of the convolution operation.

It can be seen from the above description that, in the embodiments of the present disclosure, the input tensors have fewer data compared to the original input tensor, which helps to reduce the volume of data stored in the cache 15, improve the utilization rate of the cache 15, and lessens the read bandwidth of the input tensors.

According to an embodiment of the present disclosure, the input circuit 12 is configured to read the original input tensor as the input tensor. The multiplying accumulator 11 is configured to perform steps S41 and S42 shown in FIG. 4.

Step S41 includes obtaining a position index. The position index includes reserved positions of the sparse processing.

Step S42 includes performing, based on the position index, a MAC operation on data from the input tensor corresponding to the reserved positions and the sparse weight tensor. Specifically, the multiplying accumulator 11 may obtain the sparse positions based on the position index. Based on this, in step S42, the multiplying accumulator may read the data from the input tensor corresponding to the reserved positions and skip data corresponding to the sparse positions based on the position index, and perform a MAC operation on the data read by the multiplying accumulator and the sparse weight tensor. In this way, the multiplying accumulator 11 can equivalently compute the volume of data computed before sparsification, increasing the computational power of the multiplying accumulator 11.

According to an embodiment of the present disclosure, the input circuit 12 is further configured to read the sparse weight tensor, and write the sparse weight tensor into the cache 15. The sparse weight tensor is obtained by performing the sparse processing on the original weight tensor. For example, in some possible embodiments, the sparse weight tensor may be obtained by performing an off-line sparse processing on the original weight tensor. Specifically, when the MAC operation is performed by using the original input tensor and the original weight tensor, redundant data exists in the original weight tensor. In the embodiments of the present disclosure, off-line tools and sparse algorithms can be used to perform a de-redundancy operation on the original weight tensor through pre-trained manners, so as to obtain the sparse weight tensor and ensure that a MAC result obtained by using the sparse weight tensor and the input tensor is substantially the same as an operation result of the original weight tensor and the original input tensor. In addition, the off-line tools can be further used to obtain the location index.

In some possible embodiments, off-line tools can be used to determine a sparse granularity through the sparse algorithms. Weights that need to be sparse and weights that need to be reserved in the original weight tensor can be determined based on the sparse granularity. The sparse weight tensor is obtained by performing the sparse processing on the original weight tensor.

It should be noted that, the obtaining of the sparse weight tensor through off-line tools is merely illustrative, and the present disclosure is not limited thereto. In some other embodiments, the sparse weight tensor may also be obtained in other manners.

According to an embodiment of the present disclosure, the data processing device 1 further includes a controller 13. The controller 13 is configured to perform the sparse processing on the original weight tensor to obtain the sparse weight tensor.

According to an embodiment of the present disclosure, the sparse weight tensor is obtained by performing a first sparse processing on the original weight tensor in the first dimension, and the first sparse processing adopts a first sparse granularity. In the convolution operation, the first dimension may be an output kernel quantity, an input channel, a kernel height, or a kernel width. For example, for an original weight tensor whose key features are evenly distributed in the input channel, the first sparse processing may be performed in the dimension of the input channel to obtain a result of first sparse processing, and the sparse granularity may be determined based on the channel size and the information thereof through the result of first sparse processing.

In some possible embodiments, the first sparse granularity is m:n. Every set of n data points of the original weight tensor in the first dimension is reduced into m data points through sparsification, and m and n are both positive integers and n>m.

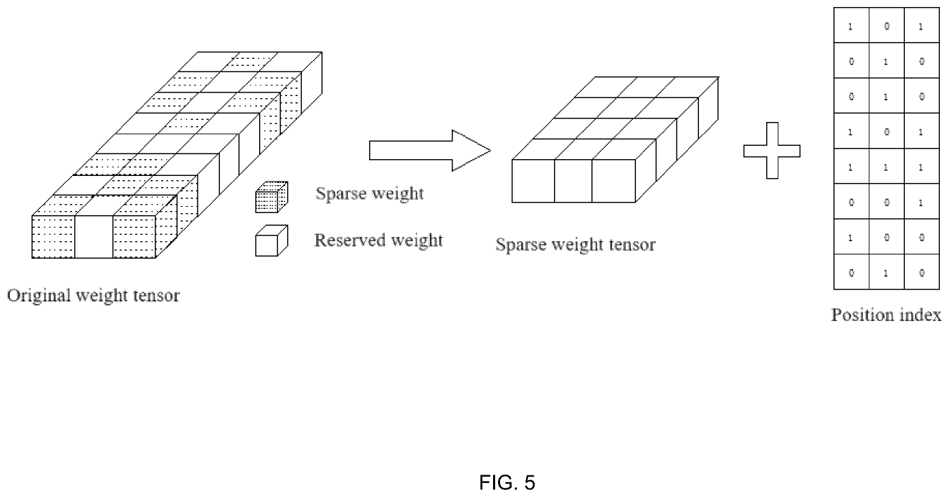

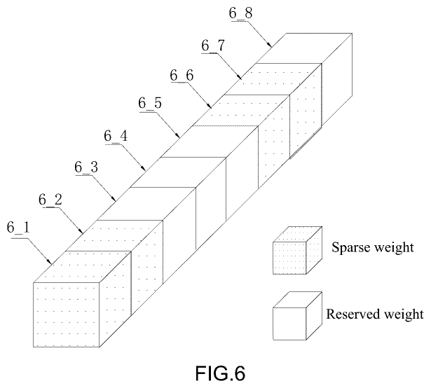

Next, the first sparse processing will be described by a specific embodiment. The channel direction (also called channel dimension) is configured as the first dimension, and the first sparse granularity is configured to be 2:4 (i.e., n=4, m=2). FIG. 5 shows a schematic diagram of a sparse processing according to an embodiment of the present disclosure. Specifically, the sparse weight tensor is obtained by performing the sparse processing on the original weight tensor. As shown in FIG. 5, the sparse processing is performed on an original weight tensor of 1×8×1×3 to obtain a sparse weight tensor of 1×4×1×3. The sparse weight refers to a weight that has undergone sparsification, and the sparse weight can be reconfigured to 0 or fixedly biased. FIG. 6 shows a schematic diagram of a sparse processing according to another embodiment of the present disclosure. Specifically, the sparse processing is performed on eight weights of the channel dimension of the original weight tensor through a sparse granularity of 2:4. As shown in FIG. 6, in the eight weights, every set of four weights is reduced into two weights through sparsification, that is, weights 6_1 to 6_4 and weights 6_5 to 6_8 are reduced into two weights, respectively. Positions of sparse weights and reserved weights can be determined by off-line tools or by the controller 13.

In some possible embodiments, the first sparse processing uses m×ceil(log₂ n) bits of position indexes to represent sparse positions, and each data point obtained through sparsification uses ceil(log₂ n) bits of position indexes to represent its position, wherein ceil is a round-up function. For example, if n=4, ceil(log₂ n)=2, and if n=5, ceil(log₂ n)=3. Specifically, in order to restore the sparse positions, each position of the reserved weights will be stored. Each position of the reserved weights needs to be stored by using ceil(log₂ n) bits of position indexes, and the first sparse processing needs to store m×ceil(log₂ n) position indexes. Taking the sparse processing shown in FIG. 6 as an example, the reserved weights 6_3 and 6_4 require two bits to represent their positions in the four weights 6_1 to 6_4, respectively, so that four bits of position indexes need to be stored in total.

In some other possible embodiments, the first sparse processing uses ceil(log₂(Cₙ^{m})) bits to represent Cₙ^{m} sparsification manners, and selects one of the Cₙ^{m} sparsification manners for execution, wherein ceil is a round-up function. Specifically, every set of n data points is reduced into m data points through sparsification, and there are a total of Cₙ^{m} sparsification manners, and each of the Cₙ^{m} sparsification manners corresponds to one combination of reserved positions and sparse positions. Taking the sparse processing shown in FIG. 6 as an example, in one of the Cₙ^{m} sparsification manners, the reserved positions may be 6_3 and 6_4, and the sparse positions may be 6_1 and 6_2, in another one of the Cₙ^{m} sparsification manners, the reserved positions may be 6_1 and 6_3, and the sparse positions may be 6_2 and 6_4, and so on. There are a total of C₄²=6 sparsification manners, and data stored in ceil(log₂(C₄²))=3 bits of position indexes indicates six sparsification manners. Therefore, the requirements for storage space are reduced, saving hardware resources. Such a sparse processing may be applied, for example, to scenarios where the sparse processing is performed in one or a few dimensions.

In some other possible embodiments, the first sparse processing uses ceil(log₂ N) bits to represent N sparsification manners, and selects one of the N sparsification manners for execution. N is an integer smaller than Cₙ^{m}, ceil is a round-up function, and the N sparsification manners are selected from the Cₙ^{m} sparsification manners. Specifically, every set of n data points is reduced into m data points through sparsification, and there are a total of Cₙ^{m} sparsification manners, and each of the Cₙ^{m} sparsification manners corresponds to one combination of reserved positions and sparse positions. In these embodiments, the Cₙ^{m} sparsification manners is further screened to remove Cₙ^{m}−N sparsification manners accounting for a low proportion, thereby obtaining the N sparsification manners. The screening of the Cₙ^{m} sparsification manners may be performed through off-line analysis manners, but the present disclosure is not limited thereto. The value of N may be an integer power of 2. Taking the sparse processing shown in FIG. 6 as an example, there are a total of C₄²=6 sparsification manners. The sparsification manners are screened through the off-line analysis manners to remove two sparsification manners accounting for a low proportion, thereby obtaining N=4 sparsification manners, and at this time, data stored in ceil(log₂ 4)=2 bits of position indexes indicates four sparsification manners. Therefore, the requirements for storage space are reduced, saving hardware resources. Such a sparse processing may be applied, for example, to scenarios where the sparse processing is performed in multiple dimensions.

It can be learned from the foregoing description that in the embodiments of the present disclosure, the sparse weight tensor is obtained by performing the sparse processing on the original weight tensor, and the sparse weight tensor is smaller in size compared to the original weight tensor. For example, in the convolution operation, for a weight of 8×64×3×3 (the four dimensions represent the output kernel quantity, the input channel, the kernel height, and the kernel width, respectively), if the sparse processing is performed in the dimension of the input channel through a sparse granularity of 2:4 (i.e., n=4, m=2), the sparse weight tensor input into the multiplying accumulator 11 is 8×32×3×3 and is halved in size compared to the original weight tensor. For another example, for a weight of 8×64×3×3, if the sparse processing is performed in the dimension of the output kernel quantity (or, kernel direction) with a sparse granularity of 2:4, the sparse weight tensor input into the multiplying accumulator 11 is 4×64×3×3 and is halved in size compared to the original weight tensor. In this way, the computational workload executed by the multiplying accumulator 11 can be reduced, the utilization rate of the multiplying accumulator 11 is improved, and the read bandwidth of partial weights can be lessened.

According to an embodiment of the present disclosure, the sparse weight tensor is obtained by performing a second sparse processing on the original weight tensor in the second dimension, and the second sparse processing adopts a second sparse granularity. In the convolution operation, the second dimension may be the output kernel quantity, input channel, kernel height, or kernel width.

In some possible embodiments, the second granularity is s:r. Every set of r data points of the original weight tensor in the second dimension is reduced into s data points through sparsification, and r and s are both positive integers and r>s.

It should be noted that the second sparse processing is similar to the first sparse processing, which will not be described here.

In one embodiment of the first aspect, an intermediate tensor may be obtained by performing the first sparse processing on the original weight tensor in the first dimension, and the sparse weight tensor may be obtained by performing the second sparse processing on the intermediate tensor in the second dimension. In another embodiment, an intermediate tensor may be obtained by performing the first sparse processing on the original weight tensor in the second dimension, and the sparse weight tensor may be obtained by performing the second sparse processing on the intermediate tensor in the first dimension. In yet another embodiment, an intermediate tensor may be obtained by performing the second sparse processing on the original weight tensor in the second dimension, and the sparse weight tensor may be obtained by performing the first sparse processing on the intermediate tensor in the first dimension. In still another embodiment, an intermediate tensor may be obtained by performing the second sparse processing on the original weight tensor in the first dimension, and the sparse weight tensor may be obtained by performing the first sparse processing on the intermediate tensor in the second dimension. The first sparse processing adopts the first sparse granularity, and the second sparse processing adopts the second sparse granularity. The first dimension and the second dimension may be the same or different from each other.

Next, the above process will be described in detail by a specific embodiment. This specific embodiment takes a convolution operation as an example, and the channel dimension is configured as the first dimension, and the dimension of the output kernel quantity is configured as the second dimension. For an original weight tensor of 8×64×3×3, the obtaining of the sparse weight tensor includes: the sparse processing (i.e., the first sparse processing) is performed on the original weight tensor in the channel dimension (i.e., the dimension of the input channel) with a sparse granularity of 2:4 to obtain the intermediate tensor, then the sparse processing (i.e., the second sparse processing) is performed on the intermediate tensor in the dimension of the output kernel quantity with a sparse granularity of 2:4 to obtain the sparse weight tensor. The sparse weight tensor is 4×32×3×3 and is only one quarter in size compared to the original weight tensor. In this way, the computational workload executed by the multiplying accumulator 11 can be further reduced. In addition, in order to restore the sparse positions, log₂n+log₂n=4 bits of position indexes need to be stored for each of the reserved weights.

In some possible embodiments, the second sparse processing may use s×ceil(log₂ r) bits of position indexes to represent sparse positions, and each data point obtained through sparsification uses ceil(log₂ r) bits of position indexes to represent its position.

In some other possible embodiments, the second sparse processing may use ceil(log₂(Cᵣ^{s})) bits to represent Cᵣ^{s} sparsification manners, and selects one of the Cᵣ^{s} sparsification manners for execution.

In some other possible embodiments, the second sparse processing may use ceil(log₂ M) bits to represent M sparsification manners, and selects one of the M sparsification manners for execution, wherein M is an integer smaller than Cᵣ^{s}, and the M sparsification manners are selected from the Cᵣ^{s} sparsification manners. According to an embodiment of the present disclosure, the channel direction of the original weight tensor may be configured as the first dimension, and the kernel direction of the original weight tensor may be configured as the second dimension.

According to an embodiment of the present disclosure, the sparse weight tensor is obtained by further performing a third sparse processing on the original weight tensor in a third dimension, and the third sparse processing adopts a third sparse granularity. The third dimension is a dimension other than the first dimension and the second dimension. For example, in the convolution operation, the third dimension may be the output kernel quantity, input channel, kernel height, or kernel width.

The embodiments of the present disclosure further provide a non-transitory computer-readable storage medium storing a computer program. The computer program is executed to implement the data processing method described above.

In some possible embodiments, any combination of one or more storage medium may be used. The storage medium may be a computer-readable signal medium or a computer-readable storage medium. Examples of non-transitory computer-readable storage medium comprise systems, devices, or components associated with electricity, magnetism, light, electromagnetism, infrared, or semiconductors, and any suitable combination thereof. More specific examples of non-transitory computer-readable storage media comprise electrical connections having one or more wires, portable computer disks, hard disks, random access memory (RAM), read-only memory (ROM), erasable programmable read-only memory (EPROM or flash memory), optical fibers, portable compressed disk read-only memory (CD-ROM), optical storage devices, magnetic storage devices, and any suitable combination thereof. In the present disclosure, the non-transitory computer-readable storage medium may be any tangible medium containing or storing programs that may be used by or in combination with instruction executing systems, devices, or components.

The embodiments of the present disclosure further provide a chip. The chip includes the data processing devices described above. In some embodiments, the chip may be neural-network processor chips.

In summary, the multiplying accumulator in the data processing device of the present disclosure performs the MAC operation using the sparse weight tensor and the input tensor, obtaining the MAC result of the original input tensor and the original weight tensor. The sparse weight tensor is obtained by performing the sparse processing on the original weight tensor, resulting in fewer data points within the sparse weight tensor compared to the original weight tensor. Compared to directly using the original input tensor and original weight tensor for MAC operations, the present disclosure reduces the computational workload. As a result, the data processing device's overall computational power is enhanced without increasing the number of multiplying accumulators. Furthermore, the data processing device of the present disclosure achieves a smaller design footprint and lower power consumption compared to related technologies while maintaining consistent computational performance. Additionally, in the present disclosure, the multiplying accumulator only needs to read the sparse weight tensor and index, reducing the weight read bandwidth. Lastly, the flexibility to configure different sparse parameters makes the data processing device of the present disclosure suitable for various application scenarios. Therefore, the present disclosure overcomes various shortcomings of the prior art and has a high industrial value.

The above-mentioned embodiments are merely illustrative of the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. A data processing device, comprising:
a multiplying accumulator, configured to:
obtain an input tensor and a sparse weight tensor, wherein the sparse weight tensor is obtained by performing a sparse processing on at least one of a first dimension and a second dimension of an original weight tensor; and
perform a multiply-accumulate (MAC) operation on the sparse weight tensor and the input tensor.

2. The data processing device of claim 1, wherein the input tensor comprises data from an original input tensor corresponding to reserved positions of the sparse processing.

3. The data processing device of claim 1, further comprising:
an input circuit, configured to:
obtain a position index that contains reserved positions of the sparse processing; and
read, based on the position index, data from an original input tensor corresponding to the reserved positions as the input tensor.

4. The data processing device of claim 1, further comprising:
an input circuit, configured to read an original input tensor as the input tensor;
wherein the multiplying accumulator is configured to:
obtain a position index that contains reserved positions of the sparse processing; and
perform, based on the position index, a MAC operation on data from the input tensor corresponding to the reserved positions and the sparse weight tensor.

5. The data processing device of claim 3, further comprising:
a controller, configured to perform the sparse processing on the original weight tensor to obtain the sparse weight tensor.

6. The data processing device of claim 4, further comprising:
a controller, configured to perform the sparse processing on the original weight tensor to obtain the sparse weight tensor.

7. The data processing device of claim 3, wherein the input circuit is configured to read the sparse weight tensor, and wherein the sparse weight tensor is obtained by performing the sparse processing on the original weight tensor.

8. The data processing device of claim 4, wherein the input circuit is configured to read the sparse weight tensor, and wherein the sparse weight tensor is obtained by performing the sparse processing on the original weight tensor.

9. The data processing device of claim 1, wherein the sparse weight tensor is obtained by performing a first sparse processing on the original weight tensor in the first dimension, and wherein the first sparse processing adopts a first sparse granularity.

10. The data processing device of claim 9, wherein the first sparse granularity is m:n, and every set of n data points of the original weight tensor in the first dimension is reduced into m data points through sparsification, wherein m and n are both positive integers and n>m.

11. The data processing device of claim 10, wherein the first sparse processing uses m×ceil(log₂ n) bits of position indexes to represent sparse positions, and each data point obtained through sparsification uses ceil(log₂ n) bits of position indexes to represent its position, wherein ceil is a round-up function.

12. The data processing device of claim 10, wherein the first sparse processing uses ceil(log₂(Cₙ^{m})) bits to represent Cₙ^{m} sparsification manners, and selects one of the Cₙ^{m} sparsification manners for execution, wherein ceil is a round-up function.

13. The data processing device of claim 10, wherein the first sparse processing uses ceil(log₂ N) bits to represent N sparsification manners, and selects one of the N sparsification manners for execution, wherein N is an integer smaller than Cₙ^{m}, ceil is a round-up function, and the N sparsification manners are selected from the Cₙ^{m} sparsification manners.

14. The data processing device of claim 1, wherein the sparse weight tensor is obtained by performing a second sparse processing on the original weight tensor in the second dimension, and wherein the second sparse processing adopts a second sparse granularity.

15. The data processing device of claim 14, wherein the second sparse granularity is s:r, and every set of r data points of the original weight tensor in the second dimension is reduced into s data points through sparsification, wherein r and s are both positive integers and r>s.

16. The data processing device of claim 1,
wherein an intermediate tensor is obtained by performing one of a first sparse processing and a second sparse processing on the original weight tensor in one of the first dimension and the second dimension, and the sparse weight tensor is obtained by performing the other of the first sparse processing and the second sparse processing on the intermediate tensor in the other of the first dimension and the second dimension,
wherein the first sparse processing adopts a first sparse granularity, and the second sparse processing adopts a second sparse granularity.

17. The data processing device of claim 1, wherein the first dimension is a channel direction of the original weight tensor, and the second dimension is a kernel direction of the original weight tensor.

18. The data processing device of claim 1, wherein the sparse weight tensor is obtained by further performing a third sparse processing on the original weight tensor in a third dimension, and the third sparse processing adopts a third sparse granularity.

19. A data processing method, comprising:
obtaining an input tensor and a sparse weight tensor, wherein the sparse weight tensor is obtained by performing a sparse processing on at least one of a first dimension and a second dimension of an original weight tensor; and
performing a multiply-accumulate (MAC) operation on the sparse weight tensor and the input tensor.

20. A chip, comprising a data processing device, wherein the data processing device comprises:
a multiplying accumulator, configured to:
obtain an input tensor and a sparse weight tensor, wherein the sparse weight tensor is obtained by performing a sparse processing on at least one of a first dimension and a second dimension of an original weight tensor; and
perform a multiply-accumulate (MAC) operation on the sparse weight tensor and the input tensor.
